(19) United States
(12) Patent Application Publication
(10) Pub. No.: US 2023/0347412 A1
(43) Pub. Date: Nov. 2, 2023

(54) ADDITIVE PROCESSING DEVICE, ADDITIVE PROCESSING DEVICE CONTROL METHOD, AND COMPUTER-READABLE RECORDING MEDIUM STORING ADDITIVE PROCESSING DEVICE CONTROL PROGRAM

(71) Applicants: INTELLIGENT MANUFACTURING SYSTEMS INTERNATIONAL, San Francisco, CA (US); DMG MORI CO., LTD., Nara (JP)

(72) Inventors: Hideki AOYAMA, Kanagawa (JP); Kazuo YAMAZAKI, San Francisco, CA (US); Erika OKAMOTO, Kanagawa (JP); Kengo AIZAWA, Kanagawa (JP); Masahiro UEDA, Nara (JP)

(73) Assignees: INTELLIGENT MANUFACTURING SYSTEMS INTERNATIONAL, San Francisco, CA (US); DMG MORI CO., LTD., NARA (JP)

(21) Appl. No.: 17/889,815

(22) Filed: Aug. 17, 2022

Related U.S. Application Data
(60) Provisional application No. 63/336,279, filed on Apr. 28, 2022.
(60) Provisional application No. 63/389,773, filed on Jul. 15, 2022.

(51) Int. Cl. B22F 10/25; B22F 12/41; B22F 12/50; B22F 12/90; B22F 10/366; B22F 10/85; B33Y 10/00; B33Y 50/02; B33Y 30/00

(52) U.S. Cl. CPC B22F 10/25; B22F 12/41; B22F 12/50; B22F 12/90; B22F 10/366; B22F 10/85; B33Y 10/00; B33Y 50/02; B33Y 30/00

(57) ABSTRACT

There is provided an additive processing device that models a workpiece by melting a supplied powder material and forming layers of the melted powder material. The additive processing device is provided with a laser head configured to supply the powder material to the workpiece and irradiate the workpiece with a laser beam, a drive unit configured to drive the laser head, a recognition unit configured to recognize a height of the workpiece in a laminating direction while the laser head is forming an N-th layer (N being a natural number) of the workpiece, a generation unit configured to generate a drive path for the laser head for formation of an N+1-th layer of the workpiece, based on the recognized height, and a control unit configured to control the drive unit based on the drive path.

### CROSS REFERENCE TO RELATED APPLICATIONS

This application claims the benefit under 35 U.S.C. § 119(e) of U.S. Provisional Application No. 63/336,279, filed Apr. 28, 2022, and U.S. Provisional Application No. 63/389,773, filed Jul. 15, 2022, the entirety of which is incorporated by reference herein.

### BACKGROUND

### Technological Field

The present disclosure relates to an additive processing device, an additive processing device control method, and a computer-readable recording medium storing an additive processing device control program.

### Description of the Related Art

In recent years, additive processing devices that are capable of modeling a workpiece (modeled object) by melting a supplied powder material and forming layers of the melted powder material have become prevalent. This type of modeling is called DED (Directed Energy Deposition). A DED type of additive processing device includes a laser head. While moving, the laser head ejects a powder material onto the workpiece and also irradiates the workpiece with a laser beam. Accordingly, the portion of the workpiece irradiated with the laser beam melts. When the powder material is supplied to the melted portion, the powder material melts and solidifies, thus forming a layer on the workpiece.

When additive processing for one layer ends, it is preferable that the laser head is driven in the laminating direction by an amount corresponding to the thickness of the layer that was formed. If error arises between the actual height of the layer and the amount that the laser head moves at this time, such error accumulates every time a layer is formed. As this error increases, the focal position of the laser beam shifts farther away from the surface of the workpiece, and as a result, the modeling accuracy decreases.

There is a method of correcting the above-described error based on the height of the workpiece actually recognized by a sensor. As one example of such a method, JP 2018-8403A published in Japan discloses a three-dimensional object manufacturing device that has a modeling speed priority mode and a modeling accuracy priority mode. In the modeling speed priority mode, this three-dimensional object manufacturing device recognizes the height of the workpiece once every five layers. On the other hand, in the modeling accuracy priority mode, the three-dimensional object manufacturing device recognizes the height of the workpiece for each layer.

The three-dimensional object manufacturing device disclosed in the above document evaluates the modeling accuracy of the workpiece based on the recognized height of the workpiece. In this way, the three-dimensional object manufacturing device merely evaluates the modeling accuracy of the workpiece, and cannot improve the workpiece modeling accuracy. Accordingly, there is demand for technology for achieving an improvement in modeling accuracy over conventional technology, based on the recognized workpiece height.

### BRIEF SUMMARY

According to one example of the present disclosure, there is provided an additive processing device that models a workpiece by melting a supplied powder material and forming layers of the melted powder material. The additive processing device includes a laser head configured to supply the powder material to the workpiece and irradiate the workpiece with a laser beam, a drive unit configured to drive the laser head, a recognition unit configured to recognize a height of the workpiece in a laminating direction while the laser head is forming an N-th layer (N being a natural number) of the workpiece, a generation unit configured to generate a drive path for the laser head for formation of an N+1-th layer of the workpiece, based on the recognized height, and a control unit configured to control the drive unit based on the drive path.

According to another example of the present disclosure, there is provided a method for controlling an additive processing device that models a workpiece by melting a supplied powder material and forming layers of the melted powder material. The additive processing device includes a laser head configured to supply the powder material to the workpiece and irradiate the workpiece with a laser beam, and a drive unit configured to drive the laser head. The method includes the steps of recognizing a height of the workpiece in a laminating direction while the laser head is forming an N-th layer (N being a natural number) of the workpiece, generating a drive path for the laser head for formation of an N+1-th layer of the workpiece, based on the height recognized in the recognizing step, and controlling the drive unit based on the drive path.

According to another example of the present disclosure, there is provided a computer-readable recording medium storing a control program for controlling an additive processing device that models a workpiece by melting a supplied powder material and forming layers of the melted powder material. The additive processing device includes a laser head configured to supply the powder material to the workpiece and irradiate the workpiece with a laser beam, and a drive unit configured to drive the laser head. The control program causing the additive processing device to execute the steps of recognizing a height of the workpiece in a laminating direction while the laser head is forming an N-th layer (N being a natural number) of the workpiece, generating a drive path for the laser head for formation of an N+1-th layer of the workpiece, based on the height recognized in the recognizing step, and controlling the drive unit based on the drive path.

These and other objects, features, aspects and advantages of the present invention will become apparent from the following detailed description of the invention, taken in conjunction with the accompanying drawings.

### BRIEF DESCRIPTION OF THE DRAWINGS

FIG. 1 is a diagram showing an example of a device configuration of an additive processing device.

FIG. 2 is a diagram showing an example of a device configuration of an additive processing machine.

FIG. 3 shows a cross-sectional view of a laser head during additive processing.

FIG. 4 is a diagram schematically showing a flow of workpiece modeling processing.

FIG. 5 is a schematic diagram showing an example of a hardware configuration of a control device.

FIG. 6 is a block diagram showing an example of a drive mechanism of the additive processing machine.

FIG. 7 is a diagram showing an example of a hardware configuration of a CNC (Computer Numerical Control) device.

FIG. 8 is a diagram for describing a functional configuration of the additive processing device.

FIG. 9 is a diagram showing an example of a positional relationship between the laser head of the additive processing machine and a workpiece.

FIG. 10 is a diagram showing an example of an image obtained from a camera.

FIG. 11 is a diagram showing an example of a generated image.

FIG. 12 is a diagram showing a relationship between the distance “d” shown in FIG. 11 and the SOD (Standoff Distance).

FIG. 13 is a diagram for describing a method for generating a drive path for the laser head.

FIG. 14 is a diagram for describing the drive path generation method in more detail.

FIG. 15 is a flowchart showing a flow of modeling processing performed by the additive processing device.

FIG. 16 is a diagram showing workpiece modeling conditions when Experiments 1 and 2 were performed.

FIG. 17 is a diagram showing the experiment results according to Experiment 1 and experiment results according to Experiment 2.

FIG. 18 is a diagram showing a workpiece modeled when Experiment 1 was performed using a proposed technique.

FIG. 19 is a diagram showing a workpiece modeled when Experiment 1 was performed using a related technique.

FIG. 20 is a diagram showing experiment results according to Experiment 1.

FIG. 21 is a diagram showing a workpiece modeled when Experiment 2 was performed using the proposed technique.

FIG. 22 is a diagram showing a workpiece modeled when Experiment 2 was performed using the related technique.

FIG. 23 is a diagram showing experiment results according to Experiment 2.

FIG. 24 is a diagram for describing a functional configuration of the additive processing device according to a first variation.

FIG. 25 is a diagram showing a cross-sectional view of a workpiece in a laminating direction.

### DETAILED DESCRIPTION OF EMBODIMENTS

Hereinafter, each embodiment according to the present invention will be described with reference to the drawings. In the following description, the same parts and constituent elements are denoted by the same reference numerals. Their names and functions are also the same. Therefore, detailed description of these will not be repeated. Note that each embodiment and each modification described below may be selectively combined as appropriate.

<A. Additive Processing Device 10>

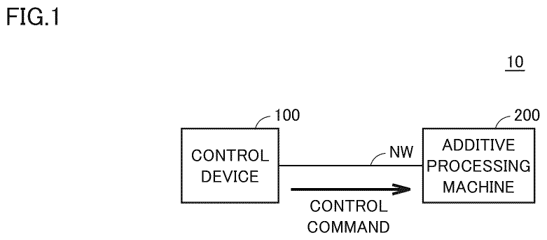

First, the device configuration of an additive processing device 10 will be described below with reference to FIG. 1. FIG. 1 is a diagram showing an example of the device configuration of the additive processing device 10.

As shown in FIG. 1, the additive processing device 10 includes a control device 100 and an additive processing machine 200.

The control device 100 controls the additive processing machine 200 by successively outputting control commands to the additive processing machine 200. The control device 100 is a desktop PC (Personal Computer), a notebook PC, a tablet terminal, or another computer having a communication function, for example.

The additive processing machine 200 is, for example, an AM/SM hybrid processing machine capable of performing workpiece additive processing (additive manufacturing (AM) processing) and workpiece subtractive processing (subtractive manufacturing (SM) processing). The SM processing function of the additive processing machine 200 includes at least either a milling function or a turning function that employs a fixing tool, for example. Note that the additive processing machine 200 may be a device that does not have an SM function.

The control device 100 and the additive processing machine 200 are disposed in a factory, for example, and are able to communicate with each other. The control device 100 and the additive processing machine 200 communicate with each other in accordance with a communication standard for industrial communication data exchange, for example. One example of such a communication standard is the international standard OPCUA (Object Linking and Embedding for Process Control Unified Architecture). The additive processing machine 200 performs workpiece additive processing in accordance with control commands from the control device 100.

Note that although FIG. 1 shows an example in which the additive processing device 10 includes one control device 100, the additive processing device 10 may include two or more control devices 100.

Also, although an example has been given in which the control device 100 is disposed in a factory, the control device 100 may be disposed outside a factory.

Also, although FIG. 1 shows an example in which the additive processing device 10 includes one additive processing machine 200, the additive processing device 10 may include two or more additive processing machines 200.

<B. Device Configuration of Additive Processing Machine 200>

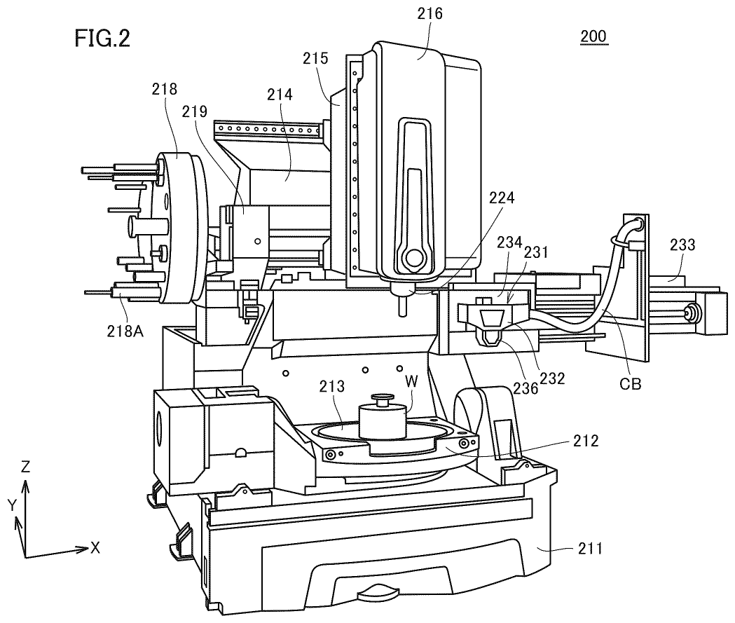

Next, an example of the device configuration of the additive processing machine 200 shown in FIG. 1 will be described with reference to FIG. 2. FIG. 2 is a diagram showing an example of the device configuration of the additive processing machine 200.

For convenience in the description, in the following, one direction on the horizontal plane will be referred to as the “X direction”. Also, the direction on the horizontal plane orthogonal to the X direction will referred to as the “Y direction”. Moreover, the direction orthogonal to both the X direction and the Y direction (i.e., the direction of gravity) will be referred to as the “Z direction”.

The additive processing machine 200 includes a machine bed 211. A turn table 212 is provided on the machine bed 211. The turn table 212 includes a rotary table 213. The rotary table 213 is rotatably attached to the turn table 212. A workpiece W to be subjected to additive processing is clamped on the rotary table 213.

As one example, the additive processing machine 200 has two axes of control with respect to the rotation of the workpiece W clamped on the rotary table 213, namely a turn axis and a rotation axis. The turn axis is an axis parallel to the upper surface of the machine bed 211. The rotation axis is an axis orthogonal to the upper surface of the turn table 212. The rotary table 213 is rotatable around the turn axis and also around the rotation axis.

The additive processing machine 200 includes a first slide mechanism 214. The first slide mechanism 214 is located in a machine column behind the machine bed 211. The first slide mechanism 214 is movable in the Y direction along a slide guide attached to the machine column.

A plurality of slide guides aligned with the X direction are arranged in the first slide mechanism 214. A second slide mechanism 215 is movable in the X direction along the slide guides.

The second slide mechanism 215 includes a subtractive processing head 216. The subtractive processing head 216 is drivable in the Z direction along the second slide mechanism 215. By controlling the driving of the first slide mechanism 214 in the Y direction, controlling the driving of the second slide mechanism 215 in the X direction, and controlling the driving of the subtractive processing head 216 in the Z direction, the additive processing machine 200 drives the subtractive processing head 216 to any position in the X direction, the Y direction, and the Z direction. Such driving is performed using servo motors, for example.

The additive processing machine 200 includes a magazine 218 for storing various units such as a tool 218A, and an automatic tool changer (ATC) 219. The tool 218A is stored in the magazine 218 when not in use. In accordance with the acceptance of a tool change instruction, the automatic tool changer 219 withdraws the unit that is to be mounted from the magazine 218, and mounts the withdrawn unit to a spindle 224.

The additive processing machine 200 further includes a laser head 231 for performing DED additive processing. The laser head 231 supplies a powder material to the workpiece W that is being subjected to additive processing, and irradiates the workpiece surface with a laser beam. The powder material may be a metal powder, a resin powder, or another type of powder that can be melted by the laser beam.

The laser head 231 includes a head body 232 and a laser nozzle 236. The powder material is supplied to the head body 232 via a cable CB. The laser nozzle 236 irradiates the workpiece with the laser beam, and also determines an irradiation region on the workpiece that is to be irradiated with the laser beam. The powder material supplied to the laser head 231 passes through the laser nozzle 236 and is discharged toward the workpiece W.

The laser head 231 is provided on a third slide mechanism 234. The third slide mechanism 234 is provided on a slide guide 233 and is drivable in the X direction. The laser head 231 is driven to an arbitrary position in the X direction in conjunction with the driving of the third slide mechanism 234. When additive processing is to be performed, the laser head 231 is driven so as to be located below the spindle 224, and is attached to the spindle 224. Upon being mounted to the spindle 224, the laser head 231 can be driven in the X direction, the Y direction, and the Z direction in conjunction with the subtractive processing head 216.

<C. Laser Head 231>

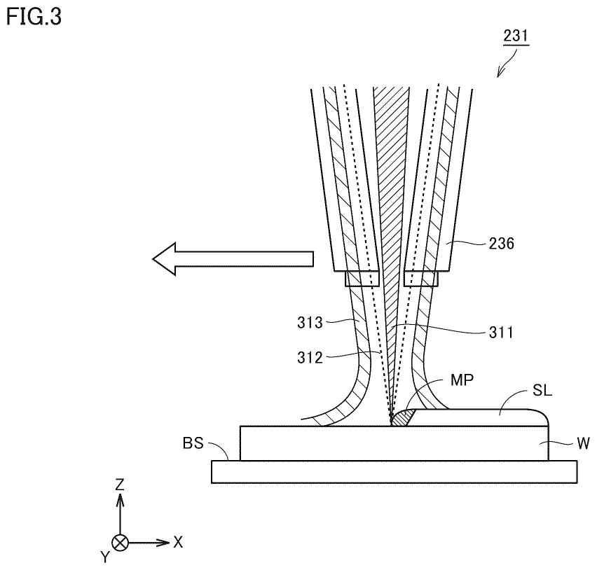

Next, additive processing performed using the laser head 231 will be described with reference to FIG. 3. FIG. 3 shows a cross-sectional view of the laser head 231 during additive processing.

In FIG. 3, the workpiece W being subjected to additive processing is shown on a base surface BS. The base surface BS represents the surface of an object. For example, the base surface BS may be the surface of a substrate, or the surface of the workpiece being subjected to additive processing.

The laser head 231 irradiates the surface of the workpiece W with a laser beam 311 while moving on the XY plane. As a result, the portion irradiated with the laser beam 311 melts, and a melt pool MP is formed on the surface of the workpiece W. In parallel with this, the laser head 231 supplies a powder material 312 to the melt pool MP. The powder material 312 is guided to the melt pool MP by a gas 313 discharged from the laser head 231. As a result, the powder material 312 melts and liquefies in the melt pool MP. Thereafter, the melt pool MP solidifies to form a layer SL on the workpiece W. Note that the gas 313 also functions as a shield gas and prevents oxidation of the workpiece W, which is a laminate.

When the additive processing of the layer SL is complete, the laser head 231 is driven in the laminating direction of the workpiece W. The “laminating direction” corresponds to a direction orthogonal to the layers. In other words, the “laminating direction” corresponds to the direction in which the layers are stacked on one another. The following description is premised on the laminating direction being the Z direction (i.e., the gravity direction), but the laminating direction is not limited to being the Z direction.

By repeatedly performing driving on the XY plane and driving in the Z direction, layers of the powder material 312 are stacked on one another. If the driving amount of the laser head 231 in the Z direction does not match the height of the formed layer SL, the focal position of the laser beam 311 shifts away from the workpiece surface each time a layer is formed. As a result, the modeling accuracy decreases. On the other hand, if the driving amount of the laser head 231 in the Z direction matches the height of the formed layer SL, the focal point of the laser beam 311 is always located on the workpiece surface, and the modeling accuracy does not decrease. For this reason, it is preferable that the distance between the laser head 231 and the workpiece surface is always constant.

<D. Overview>

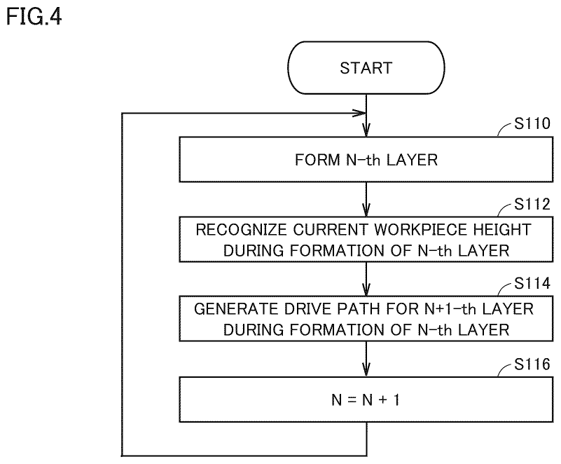

Next, an overview of modeling processing according to the present embodiment will be described with reference to FIG. 4. FIG. 4 is a diagram schematically showing a flow of workpiece modeling processing.

In step S110, the additive processing device 10 forms an N-th layer of the workpiece W by controlling the laser head 231 described above. Here, “N” is a natural number. The initial value of “N” is “1”.

As one example, in order to form the first layer (i.e., N=1) of the workpiece, the additive processing device 10 drives the laser head 231 in accordance with a control program prepared in advance. On the other hand, in order to form the second and subsequent (i.e., N≥2) layers of the workpiece, the additive processing device 10 drives the laser head 231 in accordance with a drive path generated in step S114 described later.

In step S112, while the laser head 231 is forming the N-th layer of the workpiece, the additive processing device 10 recognizes the height of the workpiece W in the laminating direction (hereinafter, also referred to as the “current workpiece height”). The current workpiece height is the distance between a predetermined reference plane and the upper surface of the N-th layer of the workpiece W, for example. The predetermined reference plane may be the above-mentioned base surface BS or a horizontal plane that includes the powder material discharge port of the laser nozzle 236.

In step S114, the additive processing device 10 generates a drive path for the laser head 231 for forming the N+1-th layer of the workpiece W based on the current workpiece height that was recognized in step S112. The drive path is generated while the laser head 231 described above is forming the N-th layer of the workpiece.

In step S116, the additive processing device 10 increments “N”. In other words, the additive processing device 10 adds 1 to “N”.

Subsequently, the additive processing device 10 executes the processing of steps S110, S112, S114, and S116 again. This processing is repeatedly executed until the current workpiece height reaches a preset target height. When the current workpiece height reaches the predetermined target height, the additive processing device 10 ends the processing shown in FIG. 4.

As described above, the additive processing device 10 successively generates a drive path for the laser head 231 for forming the N+1-th layer of the workpiece W based on the current workpiece height during formation of the N-th layer. Accordingly, the additive processing device 10 can achieve a higher workpiece modeling accuracy than in the case of driving the laser head 231 in accordance with a predetermined control program.

<E. Hardware Configuration of Control Device 100>

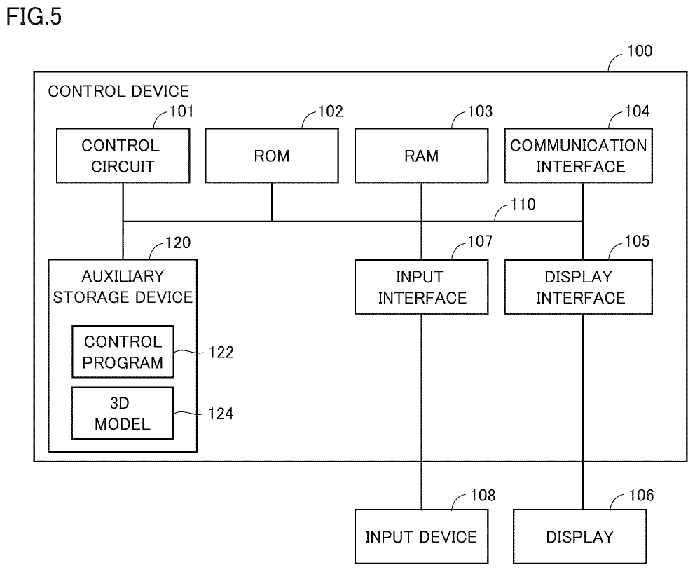

Next, a hardware configuration of control device 100 will be described with FIG. 5. FIG. 5 is a schematic diagram showing an example of hardware configuration of control device 100.

Control device 100 includes a control circuit 101, a ROM (Read Only Memory) 102, a RAM (Random Access Memory) 103, a communication interface 104, a display interface 105, an input interface 107, and an auxiliary storage device 120. These components are connected to a bus 110.

Control circuit 101 is formed of, for example, at least one integrated circuit. The integrated circuit may be formed of, for example, at least one CPU (Central Processing Unit), at least one GPU (Graphics Processing Unit), at least one ASIC (Application Specific Integrated Circuit), at least one FPGA (Field Programmable Gate Array), or a combination thereof.

Control circuit 101 controls the operation of control device 100 by executing various programs such as a control program 122 and an operating system. In response to accepting an instruction to execute control program 122, control circuit 101 reads control program 122 from auxiliary storage device 120 or ROM 102 to RAM 103. RAM 103 functions as a working memory, and temporarily stores various types of data required to execute control program 122.

Communication interface 104 is an interface to realize communication with various devices such as additive processing machine 200. As an example, control unit 100 is connected via communication interface 104 to the above-mentioned network NW (see FIG. 1). As a result, control unit 100 exchanges data with additive processing machine 200.

A display 106 is connected to display interface 105. Display interface 105 issues an image signal for displaying an image to display 106 in accordance with an instruction from control circuit 101 and the like. Display 106 is, for example, a liquid crystal display, an organic EL (Electro Luminescence) display, or another display device. Display 106 may be configured integrally with or separate from control device 100.

An input device 108 is connected to input interface 107. Input device 108 is, for example, a mouse, a keyboard, a touch panel, or another device capable of accepting a user's operation. Input device 108 may be configured integrally with or separate from control device 100.

Auxiliary storage device 120 is a storage medium such as a hard disk or a flash memory. Auxiliary storage device 120 stores control program 122, three-dimensional model 124 expressing a completed shape of the workpiece, and the like. The storage location of various data stored in auxiliary storage device 120 is not limited to auxiliary storage device 120, and they may be stored in a storage area (for example, a cache memory) of control circuit 101, ROM 102, RAM 103, an external device (for example, additive processing machine 200 or an external server), and the like.

Control program 122 may be provided not as an individual program, but by being incorporated into part of an appropriate program. Even such a program that does not include some of modules does not depart from the gist of control program 122 according to the present embodiment. Moreover, some or all of the functions provided by control program 122 may be implemented by dedicated hardware. Moreover, control device 100 may be configured in the form of so-called cloud service in which at least one server executes part of the process of control program 122.

<F. Drive Mechanism of Additive Processing Machine 200>

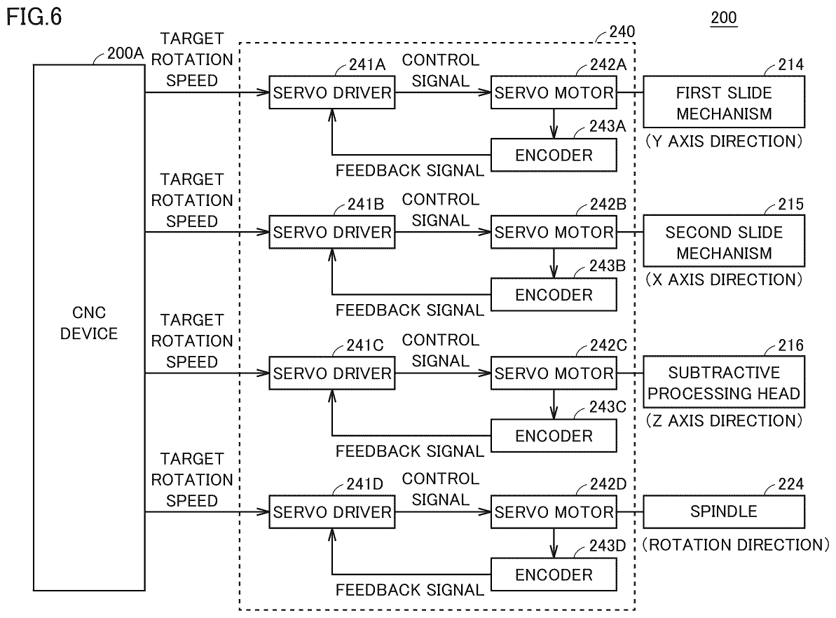

Next, an example hardware configuration of additive processing machine 200 will be described with FIG. 6. FIG. 6 is a block diagram showing an example of the drive mechanism of additive processing machine 200.

Additive processing machine 200 includes CNC device 200A, a drive unit 240, the above-described first slide mechanism 214, the above-described second slide mechanism 215, the above-described subtractive processing head 216, and the above-described spindle 224.

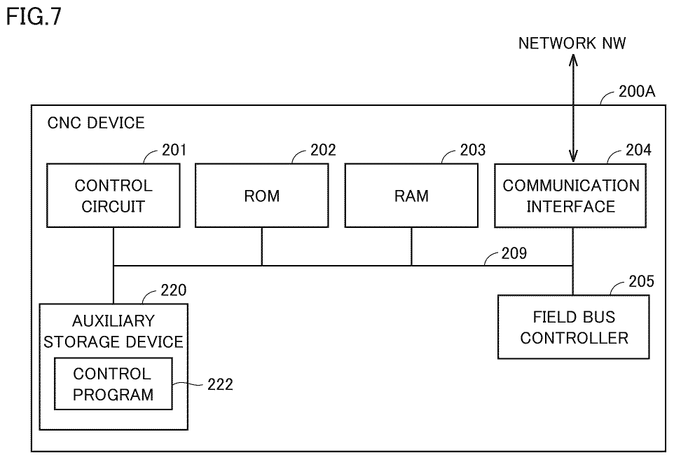

CNC device 200A controls the operation of drive unit 240 by executing various programs, such as control program 222 (see FIG. 7) described below.

Drive unit 240 is a mechanism for driving various mechanisms in additive processing machine 200. The device configuration of drive unit 240 may be in any device configuration. Drive unit 240 may be constituted by a single drive unit or multiple drive units. In the example in FIG. 6, drive unit 240 is constituted by servo drivers 241A to 241D, servo motors 242A to 242D, and encoders 243A to 243D.

Servo driver 241A sequentially receives input of a target rotational speed (or a target position) from CNC device 200A, controls servo motor 242A such that servo motor 242A rotates at the target rotational speed, and drives first slide mechanism 214 in an Y-axis direction.

More specifically, servo driver 241A calculates an actual rotational speed (or an actual position) of servo motor 242A based on a feedback signal of encoder 243A, and raises the rotational speed of servo motor 242A when the actual rotational speed is lower than the target rotational speed, and lowers the rotational speed of servo motor 242A when the actual rotational speed is higher than the target rotational speed. In this manner, servo driver 241A brings the rotational speed of servo motor 242A closer to the target rotational speed while sequentially receiving the feedback on the rotational speed of servo motor 242A. Servo driver 241A moves first slide mechanism 214 in the Y-axis direction, to move laser head 231 mounted on spindle 224 to an appropriate position in the Y-axis direction.

With similar motor control of servo driver 241A, servo driver 241B moves, in accordance with a control command from CNC device 200A, second slide mechanism 215 in the X-axis direction, to move laser head 231 mounted on spindle 224 to an appropriate position in the X-axis direction.

With similar motor control of servo driver 241A, servo driver 241C moves, in accordance with a control command from CNC device 200A, subtractive processing head 216 in the Z-axis direction, to move laser head 231 mounted on spindle 224 to an appropriate position in the Z-axis direction.

With similar motor control of servo driver 241A, servo driver 241D controls a rotational speed of spindle 224 in accordance with a control command from CNC device 200A.

The additive processing machine 200 further includes a first drive mechanism (not shown) for driving the above-described rotary table 213 (see FIG. 2) around the turn axis. The turn axis is an axis parallel to the upper surface of the machine bed 211 (see FIG. 2). The first drive mechanism is constituted by, for example, a servo driver, a servo motor, and an encoder, for example. Through motor control similar to that performed by the servo driver 241A, the servo driver controls the rotation angle of the rotary table 213 around the turn axis in accordance with control commands from the CNC device 200A.

The additive processing machine 200 further includes a second drive mechanism (not shown) for driving the above-described rotary table 213 (see FIG. 2) around the rotation axis. The rotation axis is an axis orthogonal to the upper surface of the turn table 212. The second drive mechanism is constituted by, for example, a servo driver, a servo motor, and an encoder, for example. Through motor control similar to that performed by the servo driver 241A, the servo driver controls the rotation angle of the rotary table 213 around the rotation axis in accordance with control commands from the CNC device 200A.

<G. Hardware Configuration of CNC Device 200A>

Next, a hardware configuration of CNC device 200A will be described with FIG. 7. FIG. 7 is a diagram showing an example of hardware configuration of CNC device 200A.

CNC device 200A includes a control circuit 201, a ROM 202, a RAM 203, a communication interface 204, a field bus controller 205, and an auxiliary storage device 220. These components are connected to a bus 209.

Control circuit 201 is formed of, for example, at least one integrated circuit. The integrated circuit may be formed of, for example, at least one CPU, at least one GPU, at least one ASIC, at least one FPGA, or a combination thereof.

Control circuit 201 controls the operation of CNC device 200A by executing various programs such as a control program 222. Control program 222 is a program to realize additive processing of workpieces. In response to accepting an instruction to execute control program 222, control circuit 201 reads control program 222 from ROM 202 to RAM 203. RAM 203 functions as a working memory, and temporarily stores various types of data required to execute control program 222.

Communication interface 204 is an interface to realize communication with various devices such as control device 100. As an example, additive processing machine 200 is connected via communication interface 204 to the above-mentioned network NW (see FIG. 1). As a result, additive processing machine 200 exchanges data with control unit 100.

Field bus controller 205 is a communication unit to realize communication with various units connected to field bus. One example of units connected to the field bus are various drive units (for example, servo drivers 241A to 241D, and the like) for realizing additive processing of workpieces.

Auxiliary storage device 220 is a storage medium such as a hard disk or a flash memory. Auxiliary storage device 220 stores control program 222, and the like. The storage location of control program 222 is not limited to auxiliary storage device 220, and control program 222 may be stored in a storage area (for example, a cache memory) of control circuit 201. ROM 202, RAM 203, an external device (for example, a server), and the like.

<H. Functional Configuration of Additive Processing Device 10>

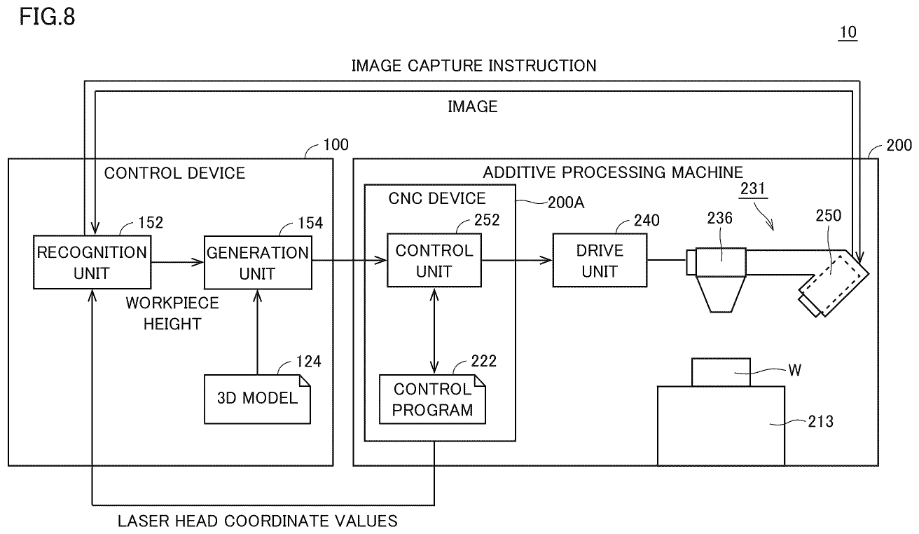

Next, the functional configuration for realizing workpiece modeling processing will be described with reference to FIGS. 8 to 14. FIG. 8 is a diagram for describing the functional configuration of the additive processing device 10.

As described above, the additive processing device 10 includes the control device 100 and the additive processing machine 200. In terms of the functional configuration, the control device 100 includes a recognition unit 152 and a generation unit 154. The additive processing machine 200 includes the above-described CNC device 200A, the above-described rotary table 213, the above-described laser head 231 and the above-described drive unit 240. In terms of the functional configuration, the CNC device 200A includes a control unit 252. Also, the CNC device 200A stores a control program 222 for performing workpiece additive processing.

Hereinafter, functions of the recognition unit 152, functions of the generation unit 154, and functions of the control unit 252 will be described in this order.

Note that the recognition unit 152 and the generation unit 154 are not necessarily required to be implemented in the control device 100. For example, the recognition unit 152 or the generation unit 154 may be implemented in the CNC device 200A or may be implemented in another device.

Also, the control unit 252 is not necessarily required to be implemented in the CNC device 200A. For example, the control unit 252 may be implemented in the control device 100 or may be implemented in another device.

H1. Recognition Unit 152

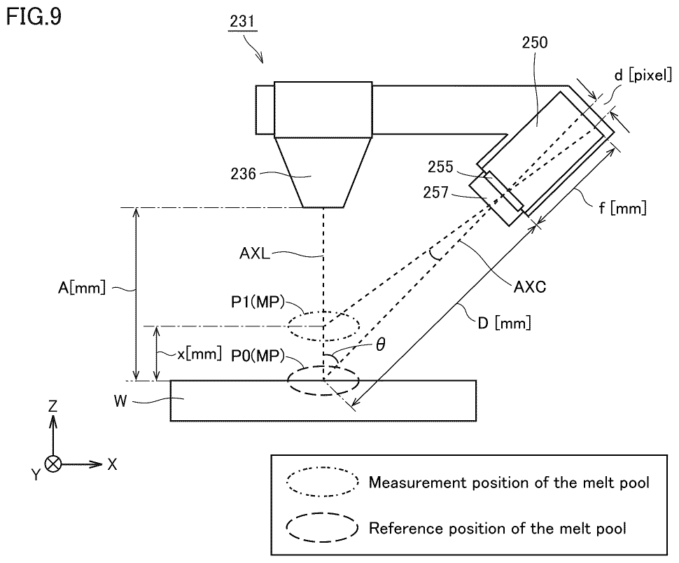

First, functions of the recognition unit 152 shown in FIG. 8 will be described with reference to FIGS. 9 to 12. FIG. 9 is a diagram showing an example of the positional relationship between the laser head 231 of the additive processing machine 200 and the workpiece W.

The recognition unit 152 recognizes the height of the workpiece W in the laminating direction while the laser head 231 is forming the N-th layer of the workpiece W (N is a natural number), that is to say the current workpiece height. The current workpiece height can be recognized using any method.

As one example, the current workpiece height is recognized using a camera 250. The camera 250 may be a CMOS (Complementary Metal Oxide Semiconductor) camera or another type of camera.

The camera 250 is configured to move in conjunction with the laser head 231. Preferably, the camera 250 is provided in the additive processing machine 200 such that an optical axis AXC of the camera 250 intersects an optical axis AXL of the laser head 231. The optical axis AXL of the laser head 231 corresponds to the laser emission direction. The optical axis AXC of the camera 250 corresponds to an axis that connects the optical center of a lens 255 to the center of the image plane of the camera 250.

The lens 255 of the camera 250 includes a welding light-shielding plate 257. In the case of DED modeling, the brightness of the melt pool is very high, and a large amount of spatter occurs. For this reason, the melt pool portion in the captured image tends to have a very high brightness and be overexposed. By providing the lens 255 with the light-shielding plate 257, the brightness of the melt pool portion is lowered, and overexposure can be prevented. Note that instead of the light-shielding plate 257, the lens 255 may be provided with another member capable of reducing the amount of light.

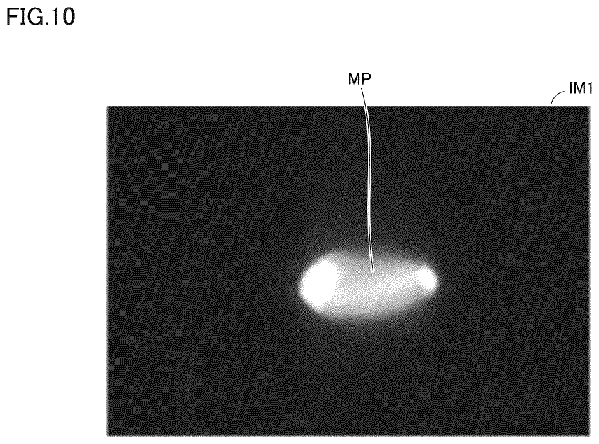

The recognition unit 152 acquires an image of the melt pool MP from the camera 250 while the laser head 231 is forming the N-th layer (N is a natural number) of the workpiece W. FIG. 10 is a diagram showing an example of an image IM1 obtained from the camera 250. In the example in FIG. 10, the melt pool MP appears in the image IM1.

The image IM1 is acquired at any time while the laser head 231 is forming the N-th layer of the workpiece W. For example, the recognition unit 152 periodically acquires the coordinate values (X, Y, Z) of the laser head 231 from the additive processing machine 200, and when the coordinate values reach predetermined coordinate values, an image capture instruction is output to the camera 250. The predetermined coordinate values are set for each layer. Upon receiving the image capture instruction, the camera 250 captures an image of the melt pool MP on the workpiece surface, and transmits the image IM1 to the recognition unit 152.

Communication between the recognition unit 152 and the camera 250 may be realized by wired or wireless communication. As one example, the camera 250 includes a communication interface such as USB (Universal Serial Bus) 2.0, and the image IM1 is sent to the recognition unit 152 via that communication interface. The image IM1 may be a still image or a moving image.

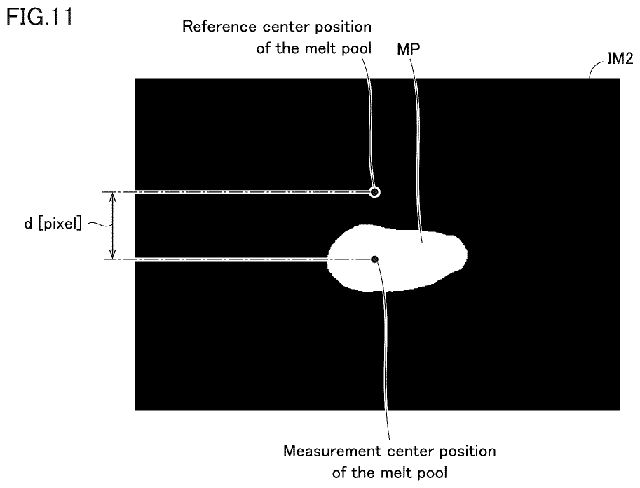

The recognition unit 152 generates an image IM2 shown in FIG. 11 by performing binarization processing on the image IM1. FIG. 11 is a diagram showing an example of the image IM2 generated from the image IM1.

If the image IM1 is a color image, the recognition unit 152 binarizes the RGB values of the pixels in the image IM1. At this time, the recognition unit 152 assigns “0” (black) to pixels whose RGB values are greater than or equal to a predetermined threshold value (e.g., 100), and assigns “255” (white) to the other pixels. This threshold value is determined in advance in accordance with the melting point temperature of the melt pool. In this way, the recognition unit 152 generates the image IM2 from the image IM1.

Next, the recognition unit 152 specifies the position of the powder material melt pool MP in the image IM2, and recognizes the current workpiece height based on the specified position. More specifically, in this processing, the recognition unit 152 first calculates the distance between the laser head 231 and the melt pool (hereinafter, also referred to as the “SOD”) based on Expression 1 shown hereinafter.

As shown in FIG. 9, in the case where the camera 250 captures an image of the melt pool MP from an angle, the position of the melt pool MP in the image IM2 is different between when the melt pool MP is at an ideal position P0 and when the melt pool MP is at a position P1 that is shifted by “x” mm from the position P0. In view of this, the recognition unit 152 calculates the SOD based on Expression 1 below, which employs triangulation.

x=(d·D)/(f·sin θ+d·cos θ) Exp. 1

In Expression 1, “d” represents the distance from the center of the image sensor of the camera 250 to the image of the melt pool MP formed on the image sensor of the camera 250. In other words, the distance “d” corresponds to the distance between a predetermined reference point in the image and the position of the melt pool in the image. Here, “d” is expressed in units of “pixel”.

Also, “D” indicates the distance between a reference position P0 of the melt pool MP and the lens 255 of the camera 250. Here, “D” is expressed in units of “mm”. Also, “D” is a known value and has been determined in advance. For example, “D” is 70 mm.

Also, ‘f’ represents the distance between the camera lens 255 of the camera 250 and the image sensor of the camera 250. Here, “f” is expressed in units of “mm”. Also, “f” is a known value and has been determined in advance. For example, “f” is 8.8 mm.

Also, “0” represents the angle formed by the optical axis AXC of the camera 250 and the optical axis AXL of the laser head 231. Here, “θ” is expressed in units of “°”. Also, “θ” is a known value and has been determined in advance. For example, “θ” is 60°.

The distance “d” is calculated based on image IM2, for example. More specifically, first, the recognition unit 152 searches for an elliptical shape in the predetermined image IM2. Any of various image processing algorithms such as Hough transform can be used as the elliptical shape search algorithm. Subsequently, the recognition unit 152 recognizes the center point of the elliptical shape as the position of the melt pool, and calculates the distance between that position and the predetermined reference position as “d”.

The recognition unit 152 specifies the distance “x” by substituting the calculated distance “d” into Expression 1. Next, the recognition unit 152 calculates the SOD at the current time (hereinafter, also referred to as the “current SOD”) by subtracting the distance “x” from an ideal SOD “A mm”. The ideal SOD has been set in advance. For example, the ideal SOD is 11 mm.

Subsequently, the recognition unit 152 calculates the current workpiece height by subtracting the current SOD from the Z coordinate of the laser head 231 during formation of the N-th layer. The Z coordinate of the laser head 231 is acquired from the CNC device 200A at the time when the image IM1 is captured, for example.

As described above, the recognition unit 152 specifies the position of the powder material melt pool in the image obtained from the camera 250 while the laser head 231 is forming the N-th layer of the workpiece W, and recognizes the current workpiece height in the laminating direction based on the specified position. The recognized current workpiece height is output to the generation unit 154.

Note that although an example has been described in which the optical axis AXC of the camera 250 is arranged so as to intersect the optical axis AXL of the laser head 231, the camera 250 may be arranged at another position. For example, the camera 250 may be arranged such that the optical axis AXC thereof is parallel with the optical axis AXL of the laser head 231.

Also, although an example has been described in which the camera 250 is configured to move in conjunction with the laser head 231, the camera 250 may be provided separately from the laser head 231. For example, the camera 250 may be provided on the ceiling inside the additive processing machine 200.

Also, although an example has been described in which the current SOD and the current workpiece height are recognized with use of the camera 250, the current SOD and the current workpiece height may be recognized with use of a sensor (e.g., a distance sensor) instead of the camera 250.

Also, although an example has been described in which the current SOD is calculated based on Expression 1, the current SOD may be calculated using a predetermined approximation expression.

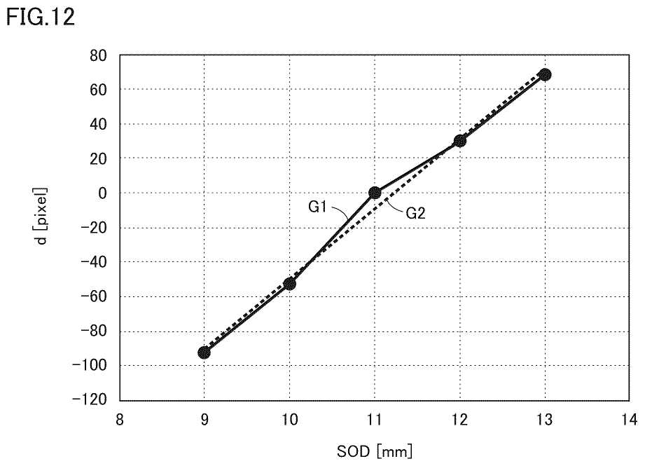

FIG. 12 is a diagram showing the relationship between the distance “d” shown in FIG. 11 and the SOD. The horizontal axis in the graph shown in FIG. 12 represents the current SOD. The vertical axis in the graph shown in FIG. 12 represents the above-described distance “d”.

A graph line G1 shown in FIG. 12 indicates actual measured values. These actual measured values were measured under the conditions that “f” is “8.8 mm”, the ideal SOD is “11 mm”, “D” is “70 mm”, and “0” is “60°”, and the relationship between the current SOD and “d” was measured accordingly. The current SOD was changed from 9 mm to 13 mm in increments of 1 mm.

The graph line G1 can be approximated by a straight line with a coefficient of determination of 0.99 (graph line G2). In the example in FIG. 12, the graph line G2 is expressed by “y=40.2x−451.4”. Here, “x” corresponds to the “current SOD” described above, and “y” corresponds to “d” described above. The recognition unit 152 can calculate the current SOD by substituting “d” in the approximation expression of the graph line G2.

In this way, the relationship between the current SOD and “d” can be specified in advance, and thus the current SOD may be calculated based on a predetermined approximation expression.

H2. Generation Unit 154

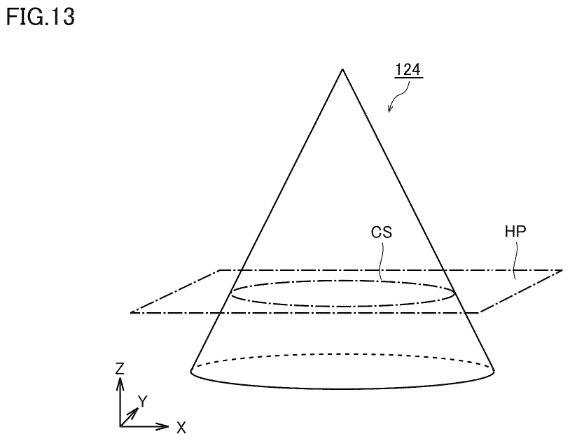

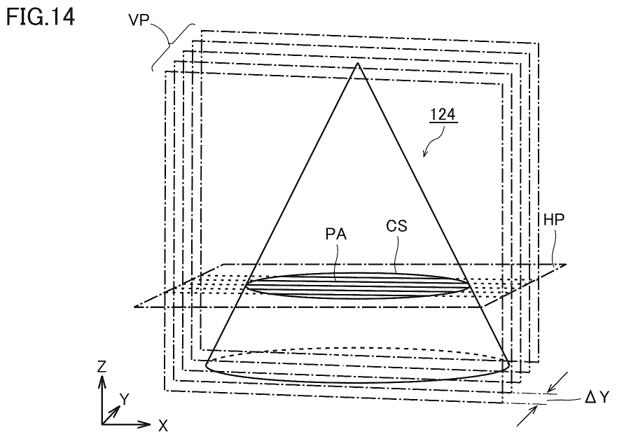

Next, functions the generation unit 154 shown in FIG. 8 will be described with reference to FIGS. 13 and 14. The generation unit 154 generates a drive path for the laser head 231 to form the N+1-th layer of the workpiece based on the current workpiece height recognized by the recognition unit 152.

The drive path is generated using a three-dimensional model 124 shown in FIG. 13, for example. FIG. 13 is a diagram for describing a method for generating a drive path for the laser head 231.

The three-dimensional model 124 is CAD (Computer Aided Design) data that expresses the completed shape of the workpiece. The three-dimensional model 124 may be stored in the control device 100 or may be stored in the CNC device 200A.

The three-dimensional model 124 may be in any data format. For example, the three-dimensional model 124 may be a wire frame model in which the three-dimensional shape is defined by a combination of points and lines, a surface model in which the three-dimensional shape is defined by a combination of faces, a spatial grid model in which information indicating the presence/absence and type of an object is associated with coordinate values in three dimensions, or another three-dimensional model that enables identifying three-dimensional coordinate values at which the powder material is to be discharged.

More specifically, in this processing, first, the generation unit 154 estimates a workpiece height for the N+1-th layer based on the current workpiece height for the N-th layer recognized by the recognition unit 152. For example, the generation unit 154 adds a predetermined value to the recognized current workpiece height in the N-th layer, and estimates the result of such addition as the workpiece height for the N+1-th layer. This predetermined value is determined in advance in accordance with the thickness of one layer that can be formed at the ideal SOD. Alternatively, the predetermined value may be calculated by subtracting the workpiece height in the N−1-th layer from the current workpiece height in the N-th layer.

Next, the generation unit 154 virtually sets a plane HP (first plane) in the three-dimensional model 124. The plane HP is a plane that corresponds to the workpiece height for the N+1-th layer and is perpendicular to the laminating direction. Subsequently, the generation unit 154 generates a drive path based on the shape of an intersection CS between the three-dimensional model 124 and the plane HP. The drive path is defined such that the powder material is discharged within the outline of the intersection CS, and furthermore the focal point of the laser is within the outline.

Note that the drive path may have any pattern as long as the powder material is discharged within the outline of the intersection CS. FIG. 14 is a diagram for describing the drive path generation method in more detail.

Preferably, the generation unit 154 not only virtually sets the plane HP in the three-dimensional model 124, but also virtually sets a plane group VP (second plane group) in the three-dimensional model 124. The plane group VP is a group of planes that are parallel with the laminating direction and are separated by an interval ΔY. Also, the group of planes in the plane group VP are orthogonal to the plane HP. The generation unit 154 generates a drive path based on the lines of intersection between the three-dimensional model 124, the plane HP, and the plane group VP.

The interval ΔY between the planes that make up the plane group VP may be set in advance or may be set automatically. As one example, the interval ΔY is set such that beam spots overlap each other by 50% (e.g., 1.5 mm).

In the example in FIG. 14, the lines of intersection between the three-dimensional model 124, the plane HP, and the plane group VP are shown as the drive path PA. In this way, the generation unit 154 defines the drive path PA such that the powder material is discharged on the lines of intersection, and furthermore the focal point of the laser is on the lines of intersection.

Note that although FIG. 14 shows an example of generation of a drive path PA for scanning within the intersection CS, the drive path PA is not limited to such a pattern. As another example, the generation unit 154 may generate a drive path PA for moving in a spiral from the center of the intersection CS. As yet another example, the generation unit 154 may generate a path driven for moving in a spiral from the outer circumference of the intersection CS toward the center of the intersection CS.

Preferably, the pattern of the drive path PA may be stored in a database in advance for each outline shape of the intersection CS. Examples of such shapes defined in the database include “circular” and “non-circular”. Here, “circular” is associated with a pattern such as a concentric circle path, a unidirectional path, or a zigzag path. Also, “non-circular” is associated with a unidirectional path or a zigzag path, for example.

The generation unit 154 references the above database and specifies a drive path pattern that corresponds to the outline shape of the intersection CS. Note that if there are a plurality of intersections CS in the modeling plane, a drive path pattern is selected in accordance with the shape of the outline of each of the intersections CS.

H3. Control Unit 252

Next, functions of the control unit 252 shown in FIG. 8 will be described.

The control unit 252 controls the drive unit 240 of the laser head 231 based on the drive path generated by the generation unit 154.

Typically, a control program 222 in which a sequence number is assigned to each control pattern is prepared in the CNC device 200A. Each control pattern includes R variables that can be specified externally. For example, at least one of the following is defined as an R variable; a movement coordinate value for the laser nozzle 236 (e.g., a movement point defined by rapid movement G00, linear interpolation G01, or are interpolation G02/G03), a movement speed of the laser nozzle 236 (e.g., the movement speed), and the turning on/off of the laser.

The generation unit 154 described above specifies a sequence number and transmits R variables that correspond to the drive path PA to the CNC device 200A. The control unit 252 of the CNC device 200A successively generates the control program 222 based on the sequence number and the R variables received from the generation unit 154.

Accordingly, during formation of the N-th layer, modeling path points for the N+1-th layer are calculated, R variables are transmitted from the control device 100 to the CNC device 200A, and the modeling program for the N+1-th layer is generated in the CNC device 200A.

<I. Control Flow>

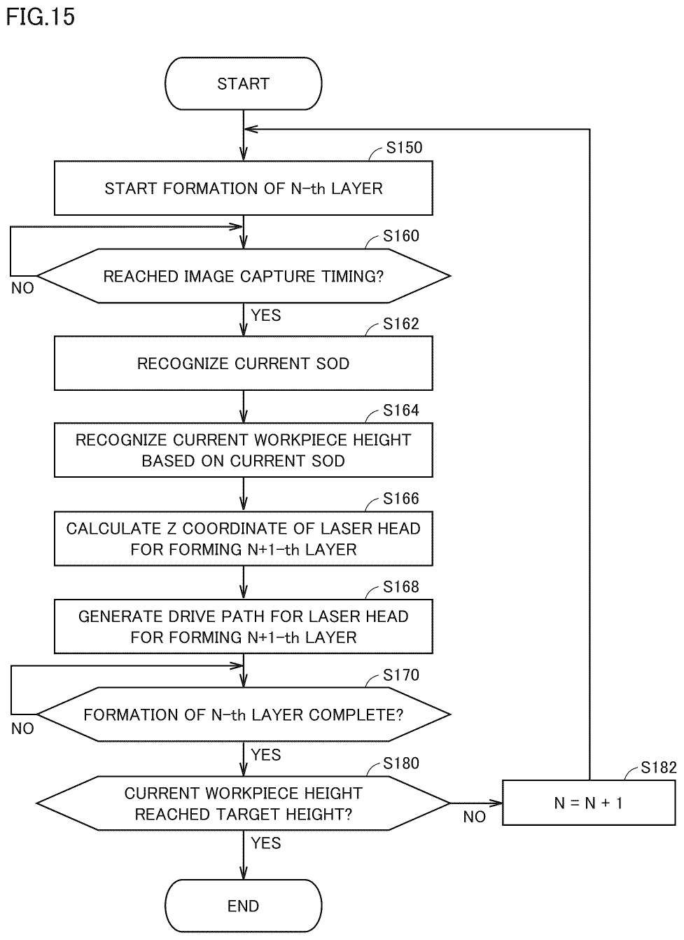

The following describes a control flow in the additive processing device 10 with reference to FIG. 15. FIG. 15 is a flowchart showing the flow of modeling processing performed by the additive processing device 10.

The processing shown in FIG. 15 may be executed by the control circuit 101 of the control device 100, or may be executed by the CNC device 200A.

In step S150, the additive processing device 10 starts formation of the N-th layer of the workpiece W. Here, “N” is a natural number. The initial value of “N” is “1”.

When forming the first layer of the workpiece (i.e., N=1), the additive processing device 10 drives the laser head 231 in accordance with a control program prepared in advance. On the other hand, when forming the second and subsequent layers of the workpiece (i.e., N≥2), the additive processing device 10 drives the laser head 231 in accordance with the output result of the processing shown in steps S166 and S168 described later.

In step S160, the additive processing device 10 functions as the above-described recognition unit 152 (see FIG. 8), and determines whether or not the workpiece image capture timing has arrived. The image capture timing arrives when, for example, the coordinate values (X, Y, Z) of the laser head 231 reach predetermined coordinate values. The predetermined coordinate values are set for each layer. In a case of determining that the workpiece image capture timing has arrived (YES in step S160), the additive processing device 10 switches the control to step S162. If otherwise (NO in step S160), the additive processing device 10 executes the processing of step S160 again.

In step S162, the additive processing device 10 functions as the above-described recognition unit 152, and outputs an image capture instruction to the camera 250. Upon receiving the image capture instruction, the camera 250 captures an image of the melt pool on the surface of the workpiece. The additive processing device 10 recognizes the current SOD based on the above-described image IM1 obtained from the camera 250. A method for recognizing the current SOD has been described above, and thus will not be described again.

In step S164, the additive processing device 10 functions as the above-described recognition unit 152, acquires the current Z coordinate of the laser head 231, and subtracts the current SOD from the Z coordinate. The additive processing device 10 recognizes the subtraction result as the current workpiece height.

In step S166, the additive processing device 10 functions as the above-described generation unit 154 (see FIG. 8), and calculates a Z coordinate for the laser head 231 for forming the N+1-th layer of the workpiece based on the current SOD recognized in step S162. At this time, the Z coordinate is calculated such that the SOD is always constant for forming each layer. Note that at the time of actual modeling, the SOD does not need to be strictly constant, and may be within a predetermined range based on the ideal SOD.

In step S168, the additive processing device 10 functions as the generation unit 154 described above, and calculates a drive path for the laser head 231 for forming the N+1-th layer of the workpiece based on the current workpiece height recognized in step S164. The drive path indicates the path of the laser head 231 on the XY plane. A method for generating a drive path has been described above, and thus will not be described again.

In step S170, the additive processing device 10 determines whether or not the formation of the N-th layer of the workpiece is complete. As one example, the additive processing device 10 determines that the formation of the N-th layer of the workpiece is complete based on the coordinate values of the laser head 231 reaching the end of the drive path of the N-th layer. In a case of determining that the formation of the N-th layer of the workpiece is complete (YES in step S170), the additive processing device 10 switches the control to step S180. If otherwise (NO in step S170), the additive processing device 10 executes the processing of step S170 again.

In step S180, the additive processing device 10 determines whether or not the current workpiece height has reached a predetermined target height. In a case of determining that the current workpiece height has reached a predetermined target height (YES in step S180), the additive processing device 10 ends the processing shown in FIG. 15. If otherwise (NO in step S180), the additive processing device 10 switches the control to step S182.

In step S182, the additive processing device 10 increments “N”. In other words, the additive processing device 10 adds 1 to “N”.

<J. Experiment Results>

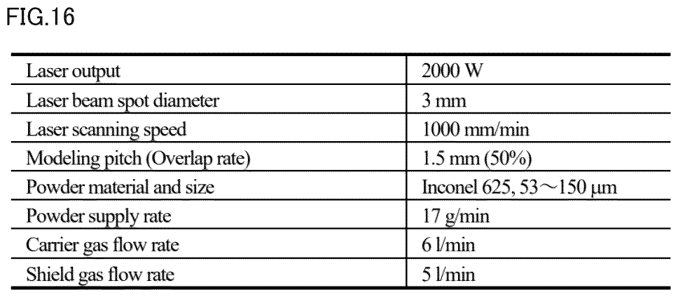

Through experimentation, the inventors confirmed the effectiveness of the modeling processing according to the above-described embodiment. Hereinafter, the results of experiments will be described with reference to FIGS. 16 to 23.

For convenience in the description, in the following, the modeling method according to the above-described embodiment is also referred to as the “proposed technique”, and a modeling method for comparison is also referred to as the “related technique”. In the proposed technique, the laser head 231 is driven such that the SOD is always constant. In the related technique, the laser head 231 is driven such that the driving amount in the laminating direction is always constant.

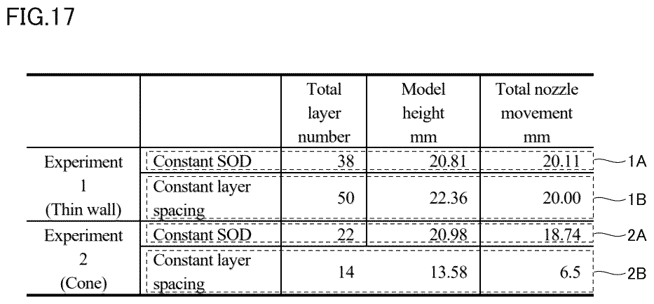

First, the inventors conducted Experiments 1 and 2. FIG. 16 is a diagram showing workpiece modeling conditions when Experiments 1 and 2 were performed. FIG. 17 is a diagram showing experiment results 1A and 1B according to Experiment 1 and experiment results 2A and 2B according to Experiment 2.

In Experiment 1, the inventors modeled a wall-shaped workpiece. The size of the workpiece had a width of 1 line, a length of 40 mm, and a height of 20 mm. In the related technique in Experiment 1, the driving amount of the laser head 231 in the laminating direction was set to 0.4 mm. Also, in Experiment 1, the scanning direction of the laser in each layer was set to one direction.

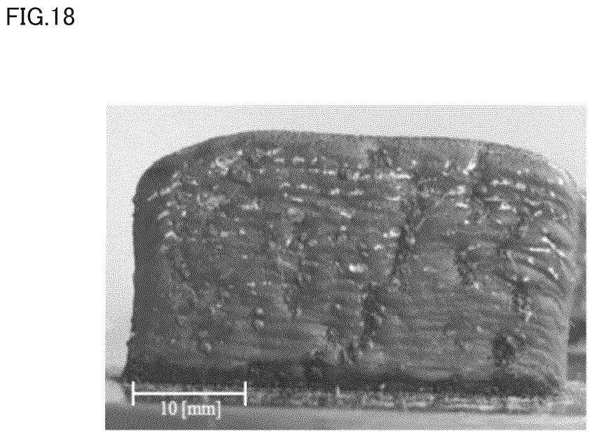

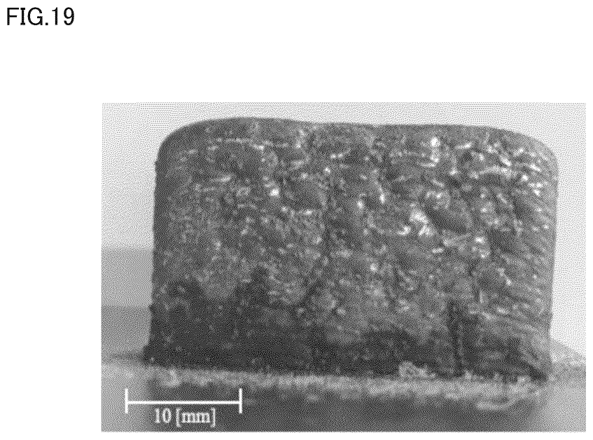

FIG. 18 is a diagram showing a workpiece modeled when Experiment 1 was performed using the proposed technique. FIG. 19 is a diagram showing a workpiece modeled when Experiment 1 was performed using the related technique.

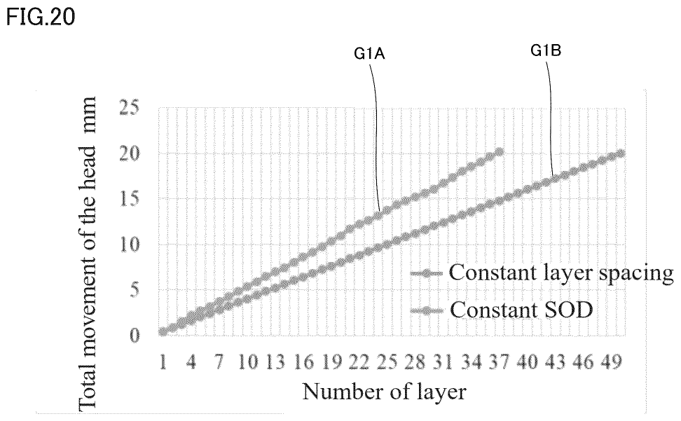

FIG. 20 is a diagram showing experiment results G1A and G1B according to Experiment 1. The horizontal axis of the graph shown in FIG. 20 indicates the layer number of the workpiece. The vertical axis of the graph shown in FIG. 20 indicates the Z coordinate of the laser head 231 relative to the first layer. Experiment result G1A shows change in the Z coordinate of the laser head 231 when the proposed technique was used. Experiment result G1B shows change in the Z coordinate of the laser head 231 when the related technique was used.

As shown in FIGS. 17 to 20, using the proposed technique, a 20.81 mm workpiece was modeled by forming 38 layers. On the other hand, using the related technique, a 22.36 mm workpiece was modeled by forming 50 layers. These results show that the modeling efficiency of the proposed technique is higher than the modeling efficiency of the related technique.

In Experiment 2, the inventors modeled a conical workpiece. The diameter of the bottom surface of the workpiece was 20 mm. The height of the workpiece was 20 mm. In the related technique in Experiment 2, the driving amount of the laser head 231 in the laminating direction was set to 0.5 mm. In Experiment 2, the scanning direction of the laser in each layer was set to a zigzag pattern.

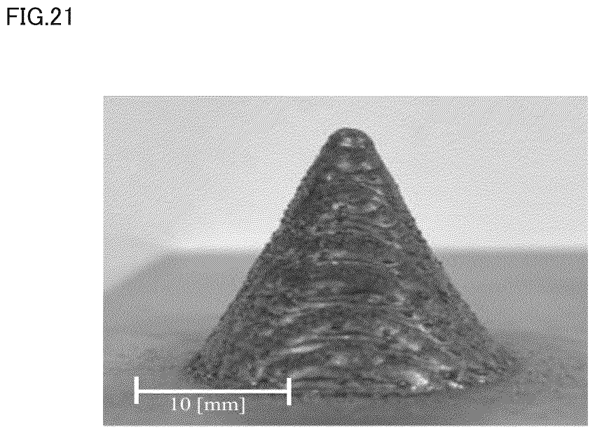

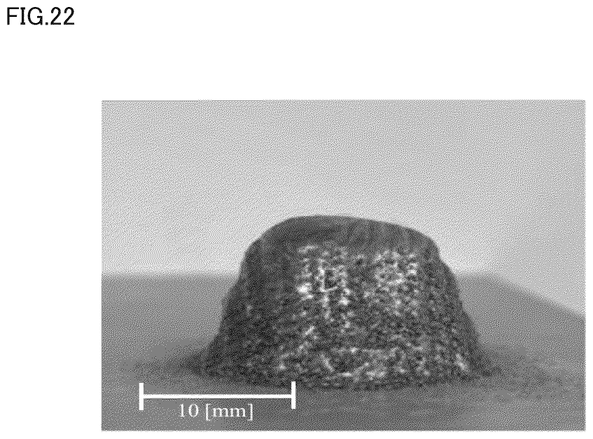

FIG. 21 is a diagram showing a workpiece modeled when Experiment 2 was performed using the proposed technique. FIG. 22 is a diagram showing a workpiece modeled when Experiment 2 was performed using the related technique.

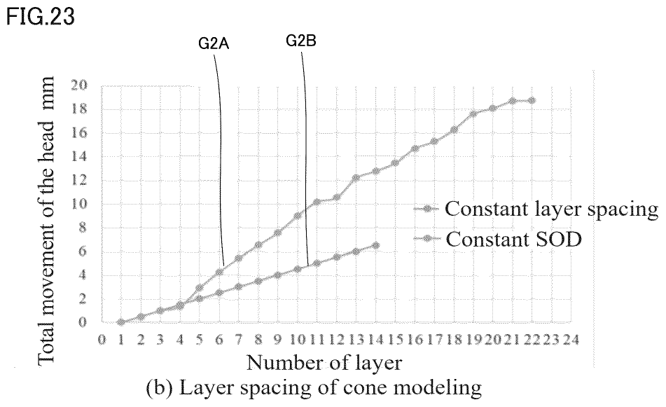

FIG. 23 is a diagram showing experiment results G2A and G2B according to Experiment 2. The horizontal axis of the graph shown in FIG. 23 indicates the layer number of the workpiece. The vertical axis of the graph shown in FIG. 23 indicates the Z coordinate of the laser head 231 relative to the first layer. Experiment result G2A shows change in the Z coordinate of the laser head 231 when the proposed technique was used. Experiment result G2B shows change in the Z coordinate of the laser head 231 when the related technique was used.

As shown in FIGS. 17 and 21-23, using the proposed technique, a 20.98 mm workpiece was modeled by forming 22 layers. On the other hand, using the related technique, the workpiece height was 13.58 mm and did not reach the target of 20 mm. The reason for this is that although the optimum SOD was 11 mm, the SOD was 3.92 mm when the fourteenth laver was formed. As described above, with the proposed technique, a workpiece having the desired shape was modeled, whereas with the related technique, a workpiece having the desired shape was not modeled. These results show that the modeling accuracy of the proposed technique is higher than the modeling accuracy of the related technique.

<K. First Variation>

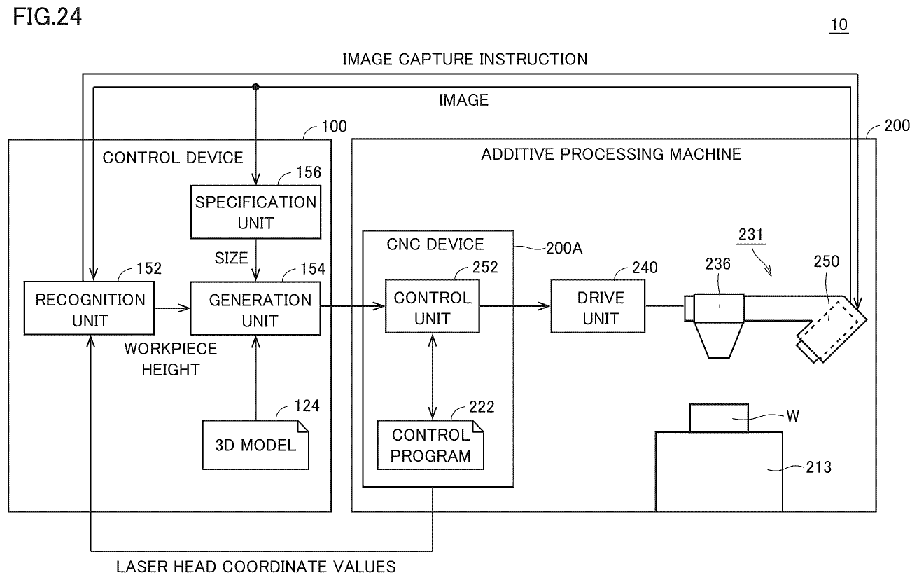

Next, the additive processing device 10 according to a first variation will be described with reference to FIG. 24.

In the example in FIG. 14 described above, the additive processing device 10 generated lines of intersection between the three-dimensional model 124, the plane HP, and the plane group VP as the drive path PA. At this time, the interval ΔY between the planes making up the plane group VP was constant. In contrast, the additive processing device 10 according to this modification determines the interval ΔY in accordance with the size of the melt pool shown in an image.

FIG. 24 is a diagram for describing the functional configuration of the additive processing device 10 according to the first variation. The additive processing device 10 shown in FIG. 24 is different from the additive processing device 10 shown in FIG. 8 in that the additive processing device 10 further includes a specification unit 156. Since the configurations other than the specification unit 156 are as described in FIG. 8, repeated descriptions will not be given for them.

The specification unit 156 specifies the size of the melt pool in an image obtained from the camera 150 while the laser head 231 is forming the N-th layer of the workpiece (N is a natural number). This size may be the area of the melt pool in the image, the width of the melt pool in the image, or any other indicator. For example, the width of the melt pool is at least either the width of the melt pool that corresponds to the driving direction of the laser head 231 or the width of the melt pool that corresponds to the direction orthogonal to the driving direction.

The size of the melt pool specified by the specification unit 156 is output to the generation unit 154. The generation unit 154 sets a larger interval ΔY between planes making up the plane group VP (second plane group) as the size of the melt pool increases. In other words, the generation unit 154 sets a smaller interval ΔY between planes making up the plane group VP as the size of the melt pool decreases. Accordingly, the generation unit 154 can generate an appropriate drive path PA that is in accordance with the size of the melt pool. As a result, the modeling accuracy of the workpiece is improved.

The relationship between the size of the melt pool and the interval ΔY may be specified in a table format or by a predetermined calculation formula. In the calculation formula, the size of the melt pool is an explanatory variable, and the interval ΔY is an objective variable.

<L. Second Variation>

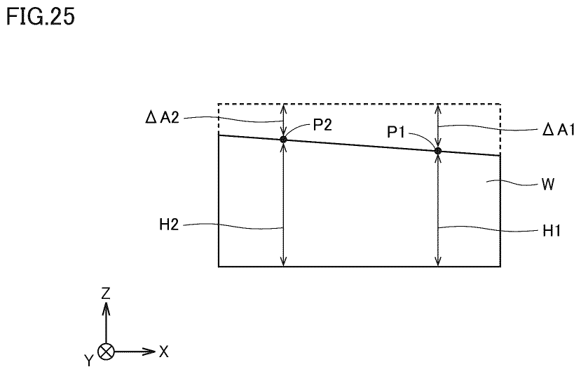

Next, the additive processing device 10 according to a second variation will be described with reference to FIG. 25.

The additive processing device 10 in the above-described configurations recognizes the current workpiece height at one place when forming the N-th layer of the workpiece. In contrast, the additive processing device 10 according to this variation recognizes the current workpiece height at a plurality of locations when forming the N-th layer of the workpiece. Based on the current workpiece height at the various locations, the control unit 252 of the additive processing device 10 changes the stacking amount at the corresponding locations when forming the N+1-th layer.

FIG. 25 is a diagram showing a cross-sectional view of the workpiece W in the laminating direction. As shown in FIG. 25, when forming the N-th layer, the additive processing device 10 recognizes a current workpiece height H1 at a location P1 (first location) and recognizes a current workpiece height H2 at a location P2 (second location). At this time, the current workpiece height H1 at the location P1 is lower than the current workpiece height H2 at the location P2. In this case, the additive processing device 10 controls the laser head 231 such that a stacking amount ΔA1 at the location P1 is larger than a stacking amount ΔA2 at the location P2 when forming the N+1-th layer of the workpiece W. Accordingly, the additive processing device 10 can achieve a uniform workpiece height when forming the N+1-th layer.

The stacking amounts ΔA1 and ΔA2 can be changed by various methods. For example, the stacking amounts ΔA1 and ΔA2 can be changed by changing the powder material discharge amount. As another example, the stacking amounts ΔA1 and ΔA2 can be changed by changing the moving speed of the laser head 231. As yet another example, the stacking amounts ΔA1 and ΔA2 can be changed by changing the number of passes of the laser head 231 at the locations P1 and P2. As still yet another example, the stacking amounts ΔA1 and ΔA2 can be changed by changing the output power of the laser head 231.

Preferably, the additive processing device 10 estimates current workpiece heights between the location P1 and the location P2 by interpolation using the current workpiece heights H1 and H2, and determines stacking amounts between the location P1 and the location P2 according to the estimation results.

Note that although an example has been described in which the current workpiece heights H1 and H2 are recognized at the two locations P1 and P2, the current workpiece height may be recognized at three or more locations. In this case, the additive processing device 10 generates a drive path for the laser head 231 for forming the N+1-th layer based on the current workpiece height recognized at each location.

<M. Third Variation>

Next, the additive processing device 10 according to a third variation will be described.

In FIG. 8 and the like described above, an example has been described in which the control device 100 is provided outside the CNC device 200A, but the control device 100 may be provided inside the CNC device 200A.

<O. Other Remarks>

As described above, embodiments of the present embodiment include the following.

Configuration 1

An additive processing device that models a workpiece by melting a supplied powder material and forming layers of the melted powder material, the additive processing device comprising:
a laser head configured to supply the powder material to the workpiece and irradiate the workpiece with a laser beam;
a drive unit configured to drive the laser head;
a recognition unit configured to recognize a height of the workpiece in a laminating direction while the laser head is forming an N-th layer (N being a natural number) of the workpiece;
a generation unit configured to generate a drive path for the laser head for formation of an N+1-th layer of the workpiece, based on the recognized height; and
a control unit configured to control the drive unit based on the drive path.

Configuration 2

The additive processing device according to configuration 1, further comprising:
a camera provided such that an optical axis of the camera intersects an optical axis of the laser head,
wherein the recognition unit
   specifies a position of a melt pool of the powder material in an image obtained from the camera while the laser head is forming the N-th layer of the workpiece, and
   recognizes the height of the workpiece in the laminating direction based on the position of the melt pool in the image.

Configuration 3

The additive processing device according to configuration 2,
wherein the camera is provided with a light-shielding plate.

Configuration 4

The additive processing device according to configuration 2 or 3,
wherein the generation unit
   acquires a three-dimensional model expressing a completed shape of the workpiece,
   estimates a height of the workpiece in formation of the N+1-th layer, based on the recognized height, and
   generates the drive path based on a shape of an intersection between the three-dimensional model and a first plane that corresponds to the estimated height and is perpendicular to the laminating direction.

Configuration 5

The additive processing device according to configuration 4,
wherein the generation unit generates the drive path based on a line of intersection between the three-dimensional model, the first plane, and a second plane group made up of planes that are parallel with the laminating direction and separated by an interval.

Configuration 6

The additive processing device according to configuration 5, further comprising:
a specification unit configured to specify a size of the melt pool in the image obtained from the camera while the laser head is forming the N-th layer of the workpiece,
wherein the generation unit sets a larger interval between planes making up the second plane group as the size of the melt pool increases.

Configuration 7

The additive processing device according to any one of configurations 1 to 6,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

Configuration 8

A method for controlling an additive processing device that models a workpiece by melting a supplied powder material and forming layers of the melted powder material,
the additive processing device including
   a laser head configured to supply the powder material to the workpiece and irradiate the workpiece with a laser beam, and
   a drive unit configured to drive the laser head, and
the method comprising the steps of:
   recognizing a height of the workpiece in a laminating direction while the laser head is forming an N-th layer (N being a natural number) of the workpiece;
   generating a drive path for the laser head for formation of an N+1-th layer of the workpiece, based on the height recognized in the recognizing step; and
   controlling the drive unit based on the drive path.

Configuration 9

A control program for controlling an additive processing device that models a workpiece by melting a supplied powder material and forming layers of the melted powder material,
the additive processing device including
   a laser head configured to supply the powder material to the workpiece and irradiate the workpiece with a laser beam, and
   a drive unit configured to drive the laser head, and
the control program causing the additive processing device to execute the steps of:
   recognizing a height of the workpiece in a laminating direction while the laser head is forming an N-th layer (N being a natural number) of the workpiece;
   generating a drive path for the laser head for formation of an N+1-th layer of the workpiece, based on the height recognized in the recognizing step; and
   controlling the drive unit based on the drive path.

The embodiment disclosed this time is an example in all respects and should be considered to be not restrictive. The scope of the present invention is defined not by the description above but by the claims, and it is intended to include meanings equivalent to the claims and all modifications within the scope.

What is claimed is:

1. An additive processing device that models a workpiece by melting a supplied powder material and forming layers of the melted powder material, the additive processing device comprising:
a laser head configured to supply the powder material to the workpiece and irradiate the workpiece with a laser beam;
a drive unit configured to drive the laser head;
a recognition unit configured to recognize a height of the workpiece in a laminating direction while the laser head is forming an N-th layer (N being a natural number) of the workpiece;
a generation unit configured to generate a drive path for the laser head for formation of an N+1-th layer of the workpiece, based on the recognized height; and
a control unit configured to control the drive unit based on the drive path.

2. The additive processing device according to claim 1, further comprising:
a camera provided such that an optical axis of the camera intersects an optical axis of the laser head,
wherein the recognition unit
specifies a position of a melt pool of the powder material in an image obtained from the camera while the laser head is forming the N-th layer of the workpiece, and
recognizes the height of the workpiece in the laminating direction based on the position of the melt pool in the image.

3. The additive processing device according to claim 2,
wherein the camera is provided with a light-shielding plate.

4. The additive processing device according to claim 2,
wherein the generation unit
acquires a three-dimensional model expressing a completed shape of the workpiece,
estimates a height of the workpiece in formation of the N+1-th layer, based on the recognized height, and
generates the drive path based on a shape of an intersection between the three-dimensional model and a first plane that corresponds to the estimated height and is perpendicular to the laminating direction.

5. The additive processing device according to claim 4,
wherein the generation unit generates the drive path based on a line of intersection between the three-dimensional model, the first plane, and a second plane group made up of planes that are parallel with the laminating direction and separated by an interval.

6. The additive processing device according to claim 5, further comprising:
a specification unit configured to specify a size of the melt pool in the image obtained from the camera while the laser head is forming the N-th layer of the workpiece,
wherein the generation unit sets a larger interval between planes making up the second plane group as the size of the melt pool increases.

7. The additive processing device according to claim 3,
wherein the generation unit
acquires a three-dimensional model expressing a completed shape of the workpiece,
estimates a height of the workpiece in formation of the N+1-th layer, based on the recognized height, and
generates the drive path based on a shape of an intersection between the three-dimensional model and a first plane that corresponds to the estimated height and is perpendicular to the laminating direction.

8. The additive processing device according to claim 7,
wherein the generation unit generates the drive path based on a line of intersection between the three-dimensional model, the first plane, and a second plane group made up of planes that are parallel with the laminating direction and separated by an interval.

9. The additive processing device according to claim 8, further comprising:
a specification unit configured to specify a size of the melt pool in the image obtained from the camera while the laser head is forming the N-th layer of the workpiece,
wherein the generation unit sets a larger interval between planes making up the second plane group as the size of the melt pool increases.

10. The additive processing device according to claim 1,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

11. The additive processing device according to claim 2,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

12. The additive processing device according to claim 3,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

13. The additive processing device according to claim 4,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

14. The additive processing device according to claim 5,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

15. The additive processing device according to claim 6,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

16. The additive processing device according to claim 7,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

17. The additive processing device according to claim 8,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

18. The additive processing device according to claim 9,
wherein the recognition unit recognizes the height of the workpiece in the laminating direction at a plurality of locations in the N-th layer of the workpiece, and
the control unit is further configured to, in a case where the height at a first location among the plurality of locations is lower than the height at a second location among the plurality of locations, control the laser head such that a stacking amount at the first location is higher than a stacking amount at the second location when forming the N+1-th layer of the workpiece.

19. A method for controlling an additive processing device that models a workpiece by melting a supplied powder material and forming layers of the melted powder material,
the additive processing device including
a laser head configured to supply the powder material to the workpiece and irradiate the workpiece with a laser beam, and
a drive unit configured to drive the laser head, and
the method comprising the steps of:
recognizing a height of the workpiece in a laminating direction while the laser head is forming an N-th layer (N being a natural number) of the workpiece;
generating a drive path for the laser head for formation of an N+1-th layer of the workpiece, based on the height recognized in the recognizing step; and
controlling the drive unit based on the drive path.

20. A computer-readable recording medium storing a control program for controlling an additive processing device that models a workpiece by melting a supplied powder material and forming layers of the melted powder material,
the additive processing device including
a laser head configured to supply the powder material to the workpiece and irradiate the workpiece with a laser beam, and
a drive unit configured to drive the laser head, and
the control program causing the additive processing device to execute the steps of:
recognizing a height of the workpiece in a laminating direction while the laser head is forming an N-th layer (N being a natural number) of the workpiece;
generating a drive path for the laser head for formation of an N+1-th layer of the workpiece, based on the height recognized in the recognizing step; and
controlling the drive unit based on the drive path.
